(19) United States
(12) Patent Application Publication
(10) Pub. No.: US 2026/0307531 A1
(43) Pub. Date: Oct. 8, 2026

(54) ELECTRICAL NETWORK IN A MOTOR VEHICLE

(71) Applicant: Volkswagen Aktiengesellschaft, Wolfsburg (DE)

(72) Inventors: Christoph POHLING, Wolfsburg (DE); Torsten STICHOWSKI, Wolfsburg (DE); Sebastian SCHMIDT-SCHAEFER, Wolfsburg (DE); Lars UMLAND, Wolfsburg (DE)

(73) Assignee: Volkswagen Aktiengesellschaft, Wolfsburg (DE)

(21) Appl. No.: 19/544,492

(22) Filed: Feb. 19, 2026

(30) Foreign Application Priority Data
Feb. 19, 2025 (DE) 10 2025 106 126.2

(51) Int. Cl. B60L 55/00; B60L 53/20; B60L 53/68; H02J 3/32

(52) U.S. Cl. CPC B60L 55/00; B60L 53/20; B60L 53/68; H02J 3/322

(57) ABSTRACT

An electrical network in a motor vehicle is provided. The electrical network has at least one DC voltage source, an inverter, at least one power outlet, and at least one control circuit for the inverter, which is designed to make a single-phase or multiphase AC voltage available at the power output. The control circuit is connected to a user interface, the user interface being designed to transfer control commands to the control circuit. A user-settable frequency of the AC voltage, which is set from the control circuit, is able to be transferred with the aid of the control commands.

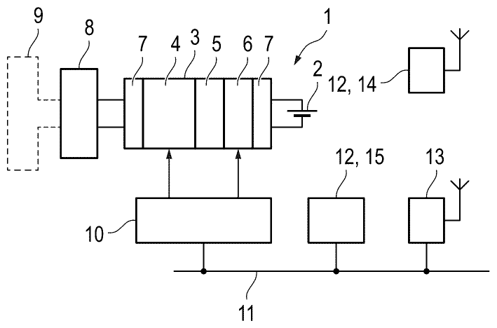

This nonprovisional application claims priority under 35 U.S.C. § 119(a) to German Patent Application No. 10 2025 106 126.2, which was filed in Germany on Feb. 19, 2025, and which is herein incorporated by reference.

### BACKGROUND OF THE INVENTION

### Field of the Invention

The invention relates to an electrical network in a motor vehicle having a power outlet.

Electrical networks in motor vehicles are known which have at least one DC voltage source, an inverter, at least one power outlet, and at least one control circuit for the inverter, the at least one control circuit for the inverter being designed to make a single-phase or multiphase AC voltage available at the at least one power outlet. The power outlet may be arranged, for example, in the motor vehicle or be accessible from the outside. Corresponding consumers, such as work machines, may then be connected to the power outlet.

### Description of the Background Art

A network of this type is known, for example from DE 10 2017 126 283 A1, DE 197 22 644 C1 or DE 101 07 023 A1.

Bidirectional charging devices (on-board chargers (OBC)) are known, which have the vehicle-to-the-grid function, i.e., a vehicle battery may be charged from the external AC power grid via a charging interface, on the one hand, and the vehicle may feed power from the battery back into the external grid, on the other hand (e.g., to stabilize it).

Electrical consumers still exist on the market which have simple electric motors, for example, a three-phase asynchronous motor or a capacitor motor in machines such as pumps, fans, and conveyor belts, which operate at a fixed rotational speed when connected to the public grid. Although the rotational speed may still be adapted by the design of the motor (number of pole pairs), this option may not be regulated and it is usually possible to switch between only two to three alternatives.

### SUMMARY OF THE INVENTION

It is therefore an object of the present invention is to improve a generic electrical network in terms of the range of applications.

The object is achieved by an electrical network having the features of claim 1. Further advantageous embodiments of the invention are derived from the subclaims.

The electrical network in a motor vehicle has at least one DC voltage source, an inverter, at least one power outlet, and at least one control circuit for the inverter, which is designed to make a single-phase or multiphase AC voltage available at the at least one power outlet. The control circuit is furthermore connected to a user interface, the user interface being designed to transfer control commands to the control circuit, a user-settable frequency of the AC voltage, which is set from the control circuit, being able to be transferred with the aid of the control commands. A rotational speed of connected consumers may be set and changed thereby. This may be desired, for example, to reduce noise development. However, it may also be desired to vary the rotational speed for other reasons. The user interface may be designed as a display and operating unit. The frequency may be settable, for example, nearly continuously or step by step, in particular, however, frequencies may be set which are different than the system frequencies (e.g., 50 Hz or 60 Hz). A maximum frequency is preferably predefined, which may be generated by the inverter. Correspondingly, a minimum frequency may also be predefined. The DC voltage source is preferably a high-voltage battery of an electric vehicle.

In a further specific embodiment, the user interface and the control circuit are also designed in such a way that a user-settable amplitude of the AC voltage, which is set from the control circuit, may be transferred via the user interface. Maximum and minimum values may also be predefined here. Alternatively or additionally, it may also be provided to set a phase angle between the current and the voltage.

In a further specific embodiment, the inverter is a constituent part of a bidirectional charging device, so that no additional components are needed.

In a further specific embodiment, the user interface is arranged in the motor vehicle.

Alternatively, the user interface may be designed as a mobile device (e.g., as a smartphone or tablet), the user interface being designed to communicate wirelessly with the network directly or indirectly. Indirectly means that the user interface communicates via a server of a service provider.

In a further specific embodiment, in a first operating mode, the user interface and the control circuit are designed to set only frequencies lower than a system frequency and/or amplitudes lower than a system amplitude. This ensures that the inverter is not overloaded. The system frequency (50 Hz or 60 Hz) represents the maximum frequency described above.

In a further specific embodiment, in a second operating mode, the control circuit and the user interface are designed to set frequencies higher than a system frequency and/or amplitudes higher than a system amplitude. This mode may be used, for example, in emergency services, for firefighting, or for technical assistance. It may be provided that this operating mode may have to be specifically enabled, since the components of the inverter and/or the connected machine may be damaged or, in extreme cases, destroyed thereby, due to heavy loading.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole FIGURE shows a schematic block diagram of an electrical network in a motor vehicle.

### DETAILED DESCRIPTION

A schematic block diagram of an electrical network 1 in a motor vehicle is illustrated in the FIGURE. Electrical network 1 has a DC voltage source 2, which is preferably designed as a high-voltage battery of an electric vehicle. However, it may also be a traction battery of a hybrid vehicle or another onboard electrical network battery. Electrical network 1 furthermore includes a bidirectional charging device 3, which is connected to DC voltage source 2. Charging device 3 has an inverter 4, a PFC stage 5, a DC/DC converter 6, and an EMC filter 7. DC/DC converter 6 is preferably a galvanically isolated DC/DC converter. Different designs of the particular assemblies are possible, which may, in part, also be integrated into other components and thus have a dual function. A power outlet 8 is connected to charging device 3, into which, for example, a work machine may be plugged as consumer 9, which has, for example, an asynchronous motor. Electrical network 1 also has a control circuit 10 for inverter 4. In the illustrated example, control circuit 10 also controls DC/DC converter 6. However, separate control circuits may also be provided.

Control circuit 10 is connected via a bus system 11 to a user interface 12, which is designed as display and operating unit 15 in the motor vehicle. Display and operating unit 15 may be, for example, a touchscreen. Alternatively or additionally, electrical network 1 also includes a receiving module 13, which receives control signals from a mobile device 14 as user interface 12 directly or indirectly via a server, which is not illustrated, and may forward them to control circuit 10 over bus system 11.

Charging unit 3 provides an AC voltage as standard at the output, which corresponds to the customary local system frequency and amplitude (e.g., 220 V with 50 Hz for a single-phase power outlet 8 in Europe).

The user may now change the set frequency and amplitude via user interface 12, so that, for example, the AC voltage is 110 V with 25 Hz. The rotational speed of the asynchronous motor of consumer 9 also changes due to the reduction of the frequency. By varying the set frequency, the rotational speed at the consumer or the electrical power converted there may thus be varied. In a first operating mode, the values for the customary local system voltage represents the upper limiting values, i.e., the frequency and the amplitude may only be reduced. It may be provided that the changes may take place only with a minimal interval (e.., 1 Hz or 5 Hz and 1 V or 5 V, respectively), so that the software adaptations in control circuit 10 are limited. Lower limits for the frequency and amplitude are also preferably predefined. For example, the lower frequency limit is 10 Hz. The lower limit for the amplitude is, for example, 100 V.

In a second operating mode, however, other maximum values may be set which are greater than the values of the customary local system voltage. However, since the aging of the structural elements is greater here, it may be provided that the user must also enable this second operating mode expressly at the risk of damage. The maximum values here may be, for example, 100 Hz and 280 V.

The specific embodiment with mobile device 14 has the advantage, in particular, that the user may be positioned in the region of consumer 9 and adjust the values for the frequency and amplitude of the AC voltage, for example because consumer 9 is rotating too fast or too slowly.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrical network in a motor vehicle, the electrical network comprising:
at least one DC voltage source;
an inverter;
at least one power outlet; and
at least one control circuit for the inverter, which is designed to make a single-phase or multiphase AC voltage available at the at least one power outlet,
wherein the control circuit is connectable to a user interface, the user interface being designed to transfer at least one control command to the control circuit, and
wherein a user-settable frequency of the AC voltage, which is set from the control circuit, is adapted to be transferred via the at least one control command.

2. The electrical network according to claim 1, wherein the user interface and the control circuit are also designed such that a user-settable amplitude of the AC voltage, which is set from the control circuit, is transferred over the user interface.

3. The electrical network according to claim 1, wherein the inverter is an integral part of a bidirectional charging device.

4. The electrical network according to claim 1, wherein the user interface is arranged in the motor vehicle

5. The electrical network according to claim 1, wherein the user interface is a mobile device, and wherein the user interface is designed to communicated wirelessly with the network directly or indirectly.

6. The electrical network according to claim 1, wherein, in a first operating mode, the user interface and the control circuit are designed to set only frequencies lower than a system frequency and/or amplitudes lower than a system amplitude.

7. The electrical network according to claim 1, wherein, in a second operating mode, the user interface and control circuit are designed to set frequencies higher than a system frequency and/or amplitudes higher than a system amplitude.
